(19) United States
(12) Patent Application Publication
(10) Pub. No.: US 2002/0162116 A1
(43) Pub. Date: Oct. 31, 2002

(54) VoIP telephony peripheral

(75) Inventors: Christopher Jensen Read, San Diego, CA (US); David H. Bessel, Poway, CA (US); Robert Hardacker, Escondido, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Corporation

(21) Appl. No.: 09/844,156

(22) Filed: Apr. 27, 2001

(51) Int. Cl. H04N 7/173; H04N 7/18; H04J 1/02

(52) U.S. Cl. 725/106; 725/131; 725/74; 370/495; 725/111

(57) ABSTRACT

A packetized voice telephony system including a set top box including a cable modem front end for supporting cable television services to be provided to a television coupled to the set top box. Also included is a voice peripheral coupled to the set top box for supporting packetized voice telephony services provided via a cable link and through the set top box. In one variation, the voice peripheral supports Voice over Internet Protocol (VoIP). The voice peripheral is external to the set top box and couples to the subscriber's telephone equipment. In some variations, the voice peripheral includes a power source to provide backup power to the set top box and the subscriber's telephone equipment.

### FIELD OF THE INVENTION

The present invention relates to packetized voice telephony provided over a cable network, and more particularly to Voice over Internet Protocol (VoIP) telephony provided over the cable network. Even more particularly, the present invention relates to integrating VoIP telephony capability into a set top box (STB) at the subscriber location.

### BACKGROUND OF THE INVENTION

Traditionally, real-time voice telephony has been provided by telephone service providers over a public switched telephone network (PSTN). The PSTN typically connects to the subscriber premises at a PSTN interface located outside of the subscriber's premises. Plain old telephone service (POTS) equipment at the subscriber's premises, including an in-house phone wiring network and POTS telephones, couple to the PSTN interface. The PSTN is known as a circuit-switched network, since all connections within the PSTN are dedicated for the duration of the telephone call.

Furthermore, state of the art communication systems are changing the way various communications services are being delivered. As such, in recent times, alternative providers, other than the traditional telephone companies, are providing telephony services. For example, cable systems operators are now capable of providing telephony services to subscribers through cable modems located at a subscriber's premises.

As an alternative to traditional circuit-switched telephony, packet-switched telephony technologies are developing, such as Voice over Internet Protocol (VoIP) technology. In this technology, voice calls are transmitted as packets of digital data representing the voice call. Since packetized voice technology provides telephony over a computer type network (i.e., the type of network that a cable network provides access to), cable providers have developed an interest in providing packetized voice telephony services, i.e. VoIP telephony, to cable subscribers.

As such, cable modem providers are developing cable modem set top boxes that can support telephony services to a subscriber in addition to the traditional cable television services. Typically, a set top box (STB) is a device for use within the subscriber's residence, usually placed on top of a television set (hence the name “set top box”) or located very close to the television set. Some STBs include a cable modem front end, which is directly coupled to the cable line from the cable provider. Thus, these STBs are self-contained interfaces to the cable network, e.g., a hybrid fiber/coax (HFC) network. These STBs may include one or more telephone interfaces that can be used to connect and support several POTS telephones using, for example, RJ-11 jacks. Such STBs also perform other functions common to the conventional cable modem, for example, by providing a connection to the subscriber's television for cable television services. Thus, a cable subscriber may place and receive telephone calls from POTS telephones coupled to the STB.

In order to efficiently utilize the packet-switched capability of the cable network, it is desired to incorporate VoIP telephony functionality within the STB. Thus, telephone calls via the STB take place as packetized voice calls, e.g., as VoIP calls, over the cable network.

Since a conventional STB is designed to be positioned in close proximity to the television set, the STB is sized such that it may easily fit on top of the television or be located within an entertainment center, without being too large, too heavy or visually obtrusive. Thus, an STB that will support VoIP telephony should be carefully designed. For example, the VoIP STB designer must be concerned with how to interface the STB to the in house wiring network and the POTS telephones. Furthermore, the designer should consider how to provide features that are specific to telephony and that aren't normally required in conventional STBs, such as, voltage to bias and ring POTS telephones, and backup power for the POTS telephones and the portions of the STB that support the VoIP telephony services in the event of a power outage. Conventional telephone service providers traditionally provide these features through the PSTN.

The present invention advantageously addresses the above and other needs.

### SUMMARY OF THE INVENTION

The present invention advantageously addresses the needs above as well as other needs by providing a voice peripheral external to and coupled to a set top box, the voice peripheral supporting packetized voice telephony and interfacing to the subscriber POTS equipment.

In one embodiment, the invention can be characterized as a packetized voice telephony system, and a method of providing a packetized voice telephony system, the system comprising a set top box including a cable modem front end for supporting cable television services to be provided to a television coupled to the set top box. Also included is a voice peripheral coupled to the set top box for supporting packetized voice telephony services provided via a cable link and through the set top box.

In another embodiment, the invention can be characterized as a packetized voice telephony system comprising a set top box including a cable modem front end and a voice peripheral coupled to the set top box and supporting packetized telephony services provided via the set top box. The voice peripheral converts packetized voice data received from the set top box to analog voice signals to be routed to subscriber POTS equipment coupled to the voice peripheral and converts analog voice signals from the subscriber POTS equipment coupled to the voice peripheral to packetized voice data to be routed to a cable network through the set top box.

In a further embodiment, the invention can be characterized as a packetized voice telephony system comprising a set top box located within a first housing and a voice peripheral located within a second housing external to the first housing and coupled to the set top box. The set top box includes a cable modem front end for receiving cable television services and packetized voice calls, wherein the cable modem front end performs television tuning and demodulation and wherein the cable modem front end separates the cable television services and the packetized voice calls. The set top box also includes a television decoder coupled to the cable modem front end. The voice peripheral receives the packetized voice calls from the set top box and supports packetized voice telephony services. The voice peripheral includes one or more telephone interfaces for coupling to subscriber POTS equipment.

In an additional embodiment, the invention can be characterized as a voice peripheral of a packetized voice cable telephony system comprising a housing external to and couplable to a set top box housing. The housing includes a processor unit adapted to be coupled to a set top box including a cable modem front end, wherein the processor unit supports packetized voice telephony services. The housing also includes one or more telephone interfaces coupled to the processor unit adapted to couple to subscriber POTS equipment.

In an added embodiment, the invention can be characterized as a method for providing packetized voice telephony including the steps of: receiving digital voice packets from a set top box including a cable modem front end that supports cable television services, wherein the digital voice packets represent a telephone call; converting the digital voice packets to an analog voice signal; and transmitting the analog voice signal to subscriber plain old telephone service (POTS) equipment.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a system level block diagram of a Voice over Internet Protocol (VoIP) telephony system including a set top box (STB) and a VoIP peripheral external to and coupled to the STB in accordance with one embodiment of the present invention;

FIG. 2 is a block diagram of one embodiment of the STB of the VoIP telephony system of FIG. 1 and illustrating one embodiment of the interconnection between the STB and the VoIP peripheral;

FIG. 3 is a block diagram of one embodiment of the VoIP peripheral of the VoIP telephony system of FIGS. 1 and 2; and

FIG. 4 is a functional block diagram of another embodiment of the STB of FIG. 2 in which communications with the VoIP peripheral are via a wireless interface.

Corresponding reference characters indicate corresponding components throughout the several views of the drawings.

### DETAILED DESCRIPTION

The following description of the presently contemplated best mode of practicing the invention is not to be taken in a limiting sense, but is made merely for the purpose of describing the general principles of the invention. The scope of the invention should be determined with reference to the claims.

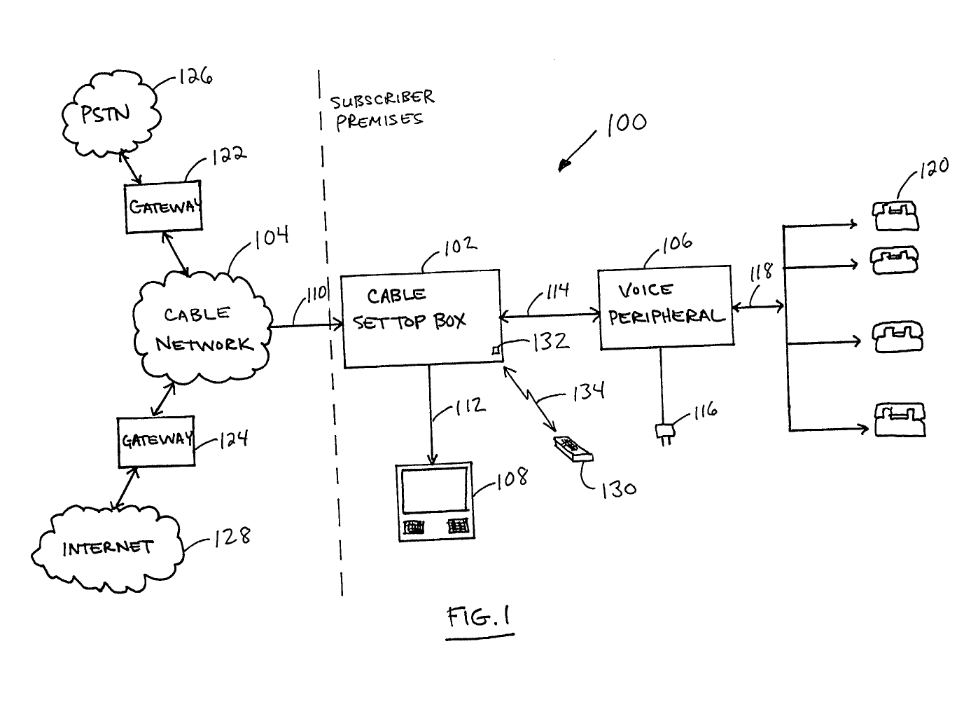

Referring first to FIG. 1, a system level block diagram is shown of a Voice over Internet Protocol (VoIP) telephony system including a set top box (STB) and a VoIP peripheral external to and coupled to the STB in accordance with one embodiment of the present invention. Shown is a VoIP telephony system 100 including a set top box 102 (also referred to as a STB 102 and including a cable modem front end or cable modem), a cable network 104, a VoIP peripheral 106 (referred to generically as a “voice peripheral”), a television 108, a cable line 110 (also referred to as a cable link), a television line 112, a peripheral link 114, a power supply 116, an in-house phone wiring network 118 (also referred to as the in-house phone wiring), POTS telephones 120, gateways 122 and 124, a public switched telephone network 126 (hereinafter referred to as PSTN 126), and an Internet 128.

In practice, cable providers within the cable network 104 provide VoIP telephony services to the subscriber via the cable line 110 and the STB 102. As is known, cable service providers conventionally provide cable television services for televisions 108 coupled to the STB 102. Additionally, in recent times, cable service providers are beginning to provide telephony services to subscribers instead of the traditional telephone companies. As such, instead of receiving telephone services from telephone lines of a Public Switched Telephone Network (PSTN) via a PSTN interface at the subscriber's premises, such services are provided via the cable line 110 from the headend of the cable network 104.

With the advent of packet switched telephony technologies, and in accordance with several embodiments of the invention, all telephone calls received into the STB 102 are packet switched, rather than circuit switched. Furthermore, the cable telephony system is designed to replace telephony services provided by a telephone service provider and to not rely on the PSTN. In one exemplary embodiment, the packetized voice telephony services to and from the STB 102 are transmitted according to the Voice over Internet Protocol (VoIP) standard, also referred to as Internet protocol (IP) telephony.

Furthermore, in accordance with several embodiments of the invention, the hardware and software supporting this packetized voice telephony is provided in a voice peripheral external to and coupled to the STB 102. As such, in a preferred embodiment, a VoIP peripheral 106 is provided that supports the VoIP telephony services and couples to the subscriber in-house telephone wiring network 118.

It should be noted that in this embodiment, the cable network 104 (e.g., a hybrid fiber/coax (HFC) network including a cable headend, etc.) may be coupled to the Internet 128 via gateway 124 and may also be coupled to the PSTN 126 via gateway 122 to connect or route calss to/from the subscriber. The cable network 104 is a type of computer network or packet network that is capable of transporting computer network data. According to several embodiments, the cable network transports packetized voice data. It is noted that the cable network 104 may be embodied as any other type of packet or computer network.

Furthermore, although this embodiment of the invention is specifically configured for VoIP communications, the invention can be adapted to handle any type of packetized voice telephony according to any number of standards other than VoIP. VoIP is a preferred embodiment of a standard for packetized voice calls.

The STB 102, as described throughout this specification, includes the cable modem front end (i.e., modulation and demodulation and interface to the cable line 110, as well as television tuning) for receiving and differentiating between packetized voice calls and cable television signaling. Additionally, as is well known, the STB 102 is normally operated by a subscriber using the remote control 130, which sends control signals over a remote link 134 to an IR (infrared) receiver 132 of the set top box 102. The remote control 130 is used by the subscriber to control the television services, e.g., to change channels, order pay-per-view, view programming schedules, etc. In other embodiments, the IR receiver 132 may be another type of receiver, such as a radio frequency (RF) receiver or other optical receiver. In contrast to telephony services provided via the PSTN 126 and the telephone companies, the cable headend of the cable network 104 does not provide such features that are commonly provided by the PSTN, such as dial tone generation, off hook detection, and power for the telephones 120 at the subscriber's location.

As such, in order to support the packetized telephony at the subscriber's location, the VoIP peripheral 106 is provided which is coupled to the STB 102 via the peripheral link 114. This VoIP peripheral 106 also couples to the subscriber in-house phone wiring network 118, to which POTS telephones 120 are attached. It is noted that in some embodiments, the POTS telephones 120 may be directly coupled to the VoIP peripheral 106.

The VoIP peripheral 106 enables the subscriber to place and receive telephone calls to and from subscribers within the PSTN 126 and within the cable network 104 and/or the Internet 128 as packetized voice calls, preferably using VoIP, from conventional POTS telephones. All calls are converted at the VoIP peripheral 106 between a digital packet transmission format to a digital data stream to an analog POTS format, although in some embodiments, the conversion between digital packet format to a digital data stream takes place collectively between the STB 102 and the VoIP peripheral 106. As such, all telephone calls placed by a subscriber that are destined for subscribers of the PSTN 126 are converted at the VoIP peripheral 106 to VoIP calls and transmitted via the STB 102 to the proper gateway, e.g., gateway 122, to the PSTN 126. Furthermore, all calls to a subscriber within the cable network 104 are also transmitted as VoIP calls.

Advantageously, this telephony system eliminates the telephone service provider completely. All telephone services, as well as television services are provided by the cable service provider. However, since the telephone service provider is not used, and thus, since various features and services normally provided by the PSTN 126 to the subscriber POTS equipment are not provided by cable service provider, these services are provided locally. As such, the VoIP peripheral 106 provides user related features such as dial tone generation, off hook detection, and call waiting. Advantageously, the subscriber does not have to purchase specialized telephone equipment to place and receive VoIP telephone calls, e.g., the user may continue to use existing POTS telephones 124 since the VoIP peripheral 106 handles the conversion from VoIP format to POTS format.

Further advantageously, the VoIP peripheral 106 provides a local backup power source such that the subscriber will still have telephone service in the event of the power outage. In one embodiment, backup power is supplied by the VoIP peripheral 106 to the STB 102 via the peripheral link 114. Thus, in one embodiment, backup power is provided to the portions of the STB 102 used to support telephony service (e.g., the cable modem front end), the in-house phone wiring network 118, the telephones 120, and to the VoIP peripheral 106 itself. This backup power is important since traditional cable providers do not provide backup power in the cable line 110 to the subscriber's premises.

The backup power supply is preferably in the form of a rechargeable battery and is advantageously located in the VoIP peripheral 106 since the backup power supply required to supply power to the STB 102 and the VoIP peripheral 106 is physically large and cumbersome. This would require unnecessary and possibly unavailable space on or near a subscriber's television. For example, a battery source to provide such power for a specified amount of time might physically measure about 6×6×8 inches and may weigh about 20 lbs. An STB 102 large enough to contain such a backup power supply would be visually obtrusive to the subscriber. This STB would also present a hazard to the subscriber since it may be too heavy to be realistically located on the television or near the television, for example, in an entertainment center. Advantageously, since the VoIP peripheral 106 is external to and coupled to the STB 102, the VoIP peripheral 106, rather than the STB 102, is configured to contain the backup power supply. Since the VoIP peripheral 106 does not have the same practical weight and size restrictions as the STB 102, the VoIP peripheral 106 may be stored remotely from the STB 102, for example, stored in a closet or under a desk. When power is available, the VoIP peripheral 106 is coupled to the power supply 116, such as provided by the local utility.

In this embodiment, the peripheral link 114 also allows for data transfer to occur between the VoIP peripheral 106 and the STB 102. Thus, all packetized voice calls from the cable network 104 are routed from the STB to the VoIP peripheral 106. The VoIP peripheral 106 includes both hardware and software to translate the packetized digital voice data of the VoIP calls to analog voice signals and analog voice signals to packetized digital voice data.

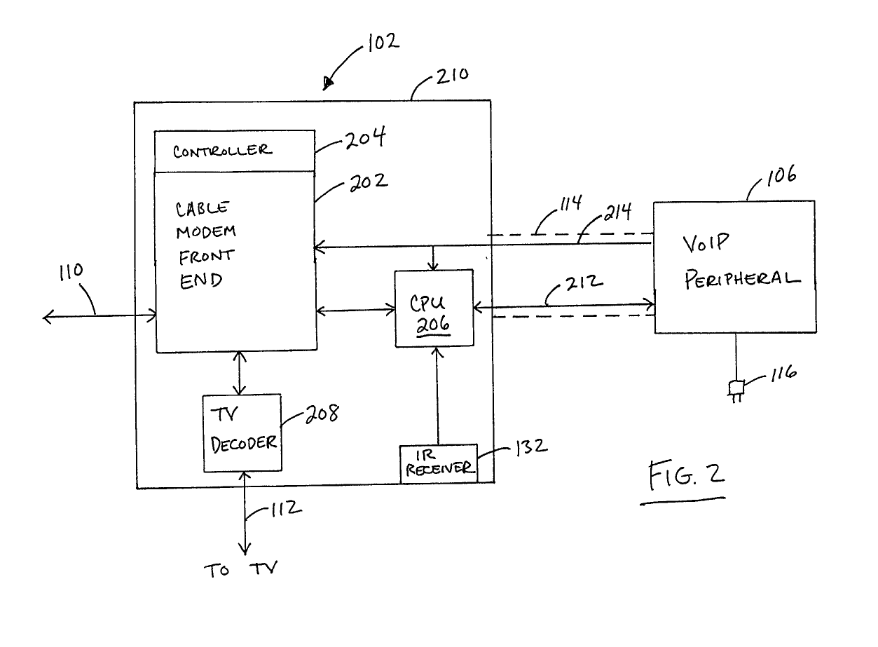

As such, the peripheral link 114 includes a data line to transfer data between the VoIP peripheral 106 and the STB 102 and also a power line to provide backup power to the STB 102. In a preferred embodiment, the peripheral link 114 is an integrated data/power line, such as an i.LINK cable, which uses the IEEE 1394 standard, and which is produced by and commercially available from Sony Electronics Inc. of Park Ridge, N.J., USA. Further details regarding the peripheral link 114 are described with reference to FIG. 2.

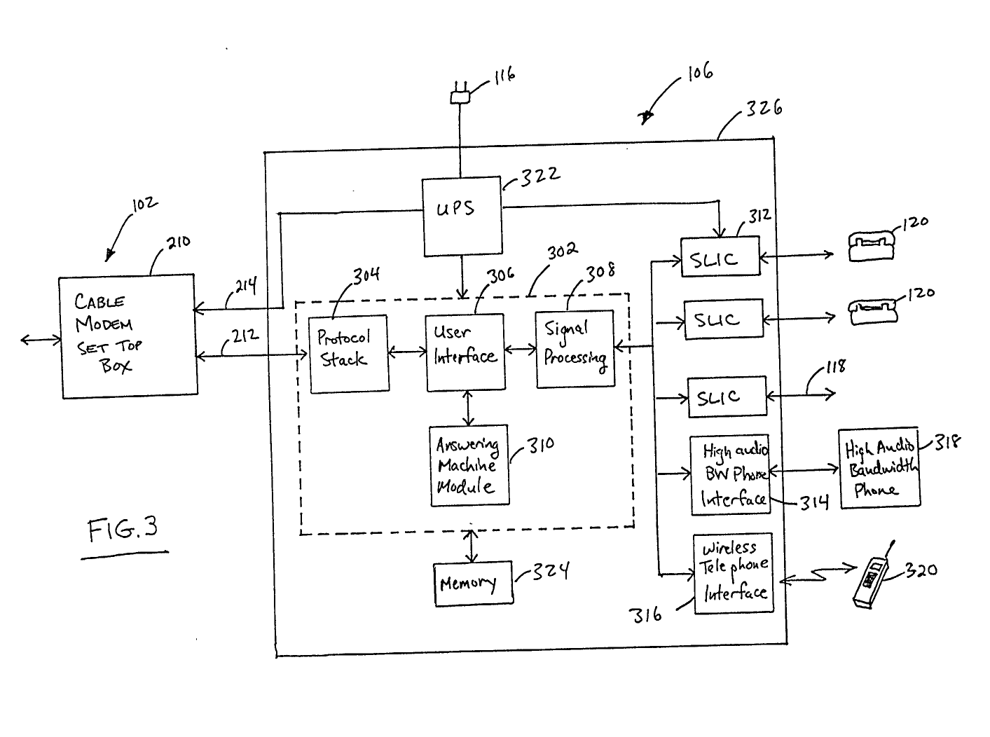

Additionally, since the VoIP peripheral is external to the STB 102, the VoIP peripheral 106 provides convenient location for coupling to the subscriber in-house phone wiring network 118. Thus, all telephones 120 within the subscriber residence will effectively be coupled to the VoIP peripheral 106. Alternatively, the VoIP peripheral 106 may include standard telephone interfaces, i.e., RJ-11 jacks, in order to directly couple the in-house phone wiring network 118 and/or one or more POTS telephone 120 to the VoIP peripheral 106. In some embodiments, additional types of telephones may be coupled to the VoIP peripheral 106, such as digital telephones or special VoIP telephones. These additional types of telephones may be coupled to the VoIP peripheral 106 via a wireline or wireless link. Other types of phones are described in more details with reference to FIG. 3.

Further advantageously, since the VoIP peripheral 106 is external to the STB and since the hardware and software to support VoIP telephony services is located in an external VoIP peripheral, the VoIP peripheral may be an add-on to existing STBs that currently receive television services. For example, a subscriber may use a STB for television services. If this subscriber wished to then subscribe to cable telephony services, more specifically, packetized voice telephony services, the cable provider could simply couple a VoIP peripheral to the existing STB 102 and such VoIP telephony services would then be available. Thus, the subscriber's STB would not require replacing. Furthermore, software could be loaded into the STB (e.g., by the cable service provider through the cable line 110) to provide the cable modem front end the ability to separate television signals from the packetized voice calls and route the packetized voice calls to the VoIP peripheral 106. Furthermore, the cable service providers do not have to design and manufacture a separate STB including the hardware and software to support these telephony services that would replace the existing STB.

As such, the VoIP peripheral 106 of several embodiments of the invention provides one or more of the following basic functions: converts all analog POTS-based telephones calls (whether to a subscriber within the PSTN 126, the cable network 104, or the Internet 128) to a digital packetized format (e.g., VoIP); converts all incoming packetized voice calls (e.g., VoIP calls) to analog telephone signals coupled to POTS equipment; provides a user interface for services normally provided by the PSTN (e.g., dial tone generation, ring signal, etc.) to seamlessly integrate existing POTS equipment into the VoIP telephony system; provides a convenient, remote location to couple to the in-house phone wiring network 118; and provides a backup power supply to ensure that cable telephone service is available during power outages. This functionality is performed without reliance upon the PSTN 126 or the use of a telephone service provider. Furthermore, the VoIP peripheral 106 is designed such that it will interface with existing POTS equipment at the subscriber's location; thus, eliminating the need for the subscriber to purchase specialized VoIP telephone equipment. And advantageously, the functionality supporting such VoIP telephony services is located in a peripheral external to the conventional STB.

Referring next to FIG. 2, a block diagram is shown of one embodiment of the STB of the VoIP telephony system of FIG. 1 and illustrating one embodiment of the interconnection between the STB and the VoIP peripheral. Shown are the STB 102, the cable line 110, the VoIP peripheral 106, the power supply 116, and the peripheral link 114. The STB 102 is contained within a housing 210 (also referred to as an STB housing) that includes a cable modem front end 202 (also referred to as a cable modem), a controller 204 (also referred to as a micro-controller), a CPU 206 (also referred to as a processor) a television (TV) decoder 208, and the IR receiver 132. The peripheral link 114 includes a data line 210 and a power line 212. The cable modem front end 202 is coupled to the cable line 110, the controller 204, the CPU 206, and the TV decoder 208. The TV decoder 208 is coupled to the television line 112 to provide television signals to a television. The CPU 206 couples the cable modem front end 202 to the VoIP peripheral 106 via the data line 212. The power line 214 provides backup power to the STB 102 in the event of a power outage; thus, the power line 114 couples to the CPU 206 and the cable modem front end 202. Furthermore, the IR receiver 132 which receives television programming control signals from a remote control operated by a subscriber is also coupled to the CPU 206.

The cable modem front end 202, the controller 204, the CPU 206 and the TV decoder 208 are common to set-top boxes that interface to a cable network. Thus, the ability of the STB 102 to support analog and digital television broadcasts as well as modulate and demodulate packetized digital information is understood to one of ordinary skill in the art. That is, the interoperation of the cable modem front end 202, the controller 204, the CPU 206 and the TV decoder 208 is known. The TV decoder 208 is typically an MPEG decoder for decoding video signals compressed using the Motion Picture Experts Group (MPEG) standard and its variants. It is also noted that, although not specifically shown in FIG. 2, the STB 102 may include other components, such as an IR transmitter, or printer ports (USB).

In this embodiment, the cable modem front end 202 performs multiple demodulation, that is, demodulates analog and digital television signals as well as packetized digital voice signals. For example, incoming digital television signals are demodulated, decrypted, decompressed and converted to analog format while incoming analog signals are also demodulated and routed to the television coupled to the STB 102. The incoming modulated voice packet data, e.g., a VoIP call, is also demodulated and routed from the cable modem front end 202 through the CPU 206 to the VoIP peripheral 106 via the data line 212.

In one embodiment, the data line 212 digitally carries the digital voice packets representing the VoIP call to the VoIP peripheral 106. Thus, no AD/DA conversion is required within the STB 102.

Outbound packetized voice data, e.g., VoIP packets, from the VoIP peripheral 106 are routed via the data line 212 through the CPU 206, modulated by the cable modem front end 202 and transmitted via the cable line 110 to the proper destination.

In this embodiment, the peripheral link 114 includes both the data line 212 and the power line 214. In a preferred embodiment, the data line 212 and the power line 214 are integrated into a single cable, which may be referred to as an “integrated power/data line”. In one embodiment, the integrated power/data line is an i.LINK cable which is based upon the IEEE 1394 standard as described above and is well known in the art. The power line portion (shown as the power line 214) of the integrated power/data line comprises a single pair of wires while the data line portion (shown as data line 212) comprises two twisted-wire signal pairs. Each twisted pair of signal wires is shielded as well as the entire cable, as is known in the art. Thus, the peripheral link 114 offers digital transport at data transmission rates that exceed 100 Mbps. This allows uncompressed digital audio to transfer between the STB 102 and the VoIP peripheral 106 while at the same time providing enough power (up to 1.5 amps at 40 VDC) to power VoIP and related hardware from a distance. In some cases, the peripheral link 114 can be up to 13 ft (4 m) in length.

Another benefit of the integrated power/data line embodiment, such as the i.LINK embodiment, is the ability of the VoIP peripheral 106 to provide both power and information in a single cable. This allows a much “cleaner” connection between the STB 102 and the VoIP peripheral 106. This is an attractive feature to subscribers where additional wires and lines would create undesired clutter near a traditional STB.

Preferably, the STB 102 is designed for manufacture with the ports adapted to be coupled to the peripheral link 118 embodied as an integrated power/data line, such as the i.LINK cable. Thus, the STB 102 is designed to operate with and support the functionality of the VoIP peripheral 106. Otherwise, modifications to an ordinary STB will have to be made.

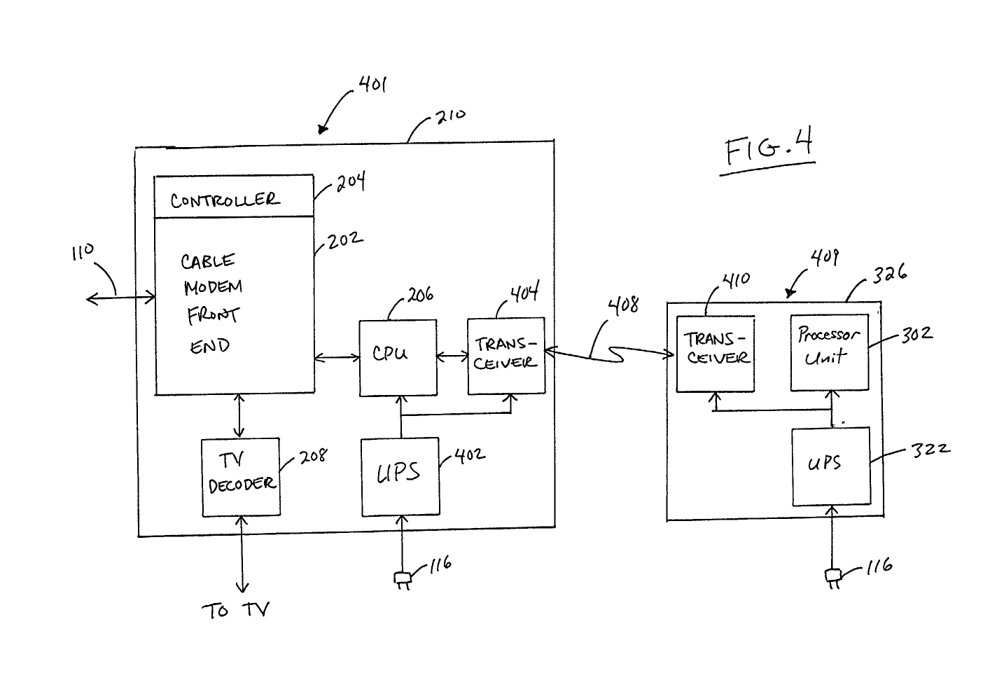

It is noted that in some embodiments, the data line 212 and the power line 214 may comprise physically separate cables or lines to the STB 102. In other embodiments, the data line 212 may comprise an Ethernet link, a universal serial bus (USB), or a HPNA (Home Phoneline Networking Alliance) link, both of which are well known in the art. In other embodiments, the link between the STB 102 and the VoIP peripheral 106 is wireless as described with reference to FIG. 4.

In the embodiments where the peripheral link 114 is an integrated power/data line, such as an IEEE 1394 cable (e.g., i.LINK), the CPU 206 includes a protocol stack that ensures that the voice packets are in the proper format for transmission over the data line 212 to the VoIP peripheral 106. In some embodiments, a separate i.LINK chip couples from the CPU 206 to the peripheral link 114 to enable digital data transfer of voice packets via the IEEE 1394 cable.

It is noted that in some embodiments, some of the functionality of the protocol stack of the VoIP peripheral 106 may be included within the CPU 206. For example, the CPU 206 executes software to assemble voice packets (e.g., VoIP packets) then convert the voice packets into a digital stream for transmission over the peripheral link 114. Further details with regard to this embodiment are described below with reference to FIG. 3.

Ordinarily, an STB receives its own power from the local utility; however, such STBs do not have a backup power supply, such as a battery. In this embodiment, the STB 102, however, is not required to have its own power supply (thus, one is not shown), but it may have its own connection to a power supply from the utility so that it may operate independently of other components. In this embodiment, when there is a power failure, the power line 214 supplies backup power to the components of the STB 102 that support the VoIP telephony services, such as, the cable modem front end 202, the controller 204, and the CPU 206. Hardware components unnecessary to digital telephony functionality, typically those components directed solely to television services, e.g., the TV decoder 208, are not provided backup power in this embodiment because ordinarily the television will not be operable in periods of power failure; however, in some embodiments, all of the components of the STB 102 may be supplied backup power from the VoIP peripheral 106. In other embodiments, the VoIP peripheral 106 may supply full-time power to the STB 102.

Of particular advantage, since the backup power supply is contained within the VoIP peripheral 106, the backup power supply may be stored out of sight in a convenient location, such as the bottom of an entertainment center. Thus, heavy, bulky, batteries are not located within the STB 102. This avoids the problem of further crowding the area immediate to the television and mitigates the danger that a STB (that includes a large and heavy backup battery) could accidentally fall from the television or other elevated position. Referring next to FIG. 3, a block diagram is shown of one embodiment of the VoIP peripheral 106 of the VoIP telephony system of FIGS. 1 and 2. Shown is the STB 102 within the housing 210 (also referred to as the STB housing), the data line 212, the power line 214, the in-house phone wiring network 118, POTS telephones 120 (the in-house phone wiring network 118 and the POTS telephones 120 may collectively be referred to as POTS equipment), a high audio bandwidth telephone 318, a digital wireless telephone 320, the power supply 116 and the VoIP peripheral 106 contained within housing 326 (also referred to as a peripheral housing). The VoIP peripheral 106 includes a processor unit 302, subscriber line interface circuits 312 (hereinafter referred to as SLICS 312 and generically referred to as telephone interfaces), a high audio bandwidth phone interface 314, a wireless telephone interface 316, an uninterruptible power supply 322 (also referred to as UPS 322), and a memory 324. The processor unit 302 comprises the following functional blocks: a protocol stack 304, a user interface module 306, a signal processing module 308 and an answering machine module 310 (also referred to as a voice messaging module).

The processor unit 302 is coupled to the data line 212, the SLICs 312, the high audio bandwidth phone interface 314, the wireless telephone interface 316, the memory 324 and the UPS 322. The various functional blocks within the processor unit 302 are shown as functional blocks, but are understood to be software algorithms running on the processor unit 302. The processor unit 302 may comprise a single processor such as a CPU, or alternatively comprise several processors, including one or more of the following: a controller, a CPU, an application specific integrated circuit (ASIC), and a digital signal processor (DSP). The POTS telephones 120 are coupled to respective SLICs 312. The high audio bandwidth telephone 318 is coupled to the high audio bandwidth phone interface 314 and the digital wireless handset 320 is coupled to the wireless telephone interface 316. The UPS 322 draws power from the power supply 116 and is coupled to the power line 214 and to all hardware components within the VoIP peripheral 106. The UPS 422 includes a rechargeable battery to provide backup power in the event of a power outage.

In practice, digital voice packets, e.g., VoIP packets, are received from the data line 212 into the processor unit 302 of the VoIP peripheral 106. The processor unit 302 assembles and orders the arriving VoIP packets (optionally decompresses them) then converts them to a digital data stream, e.g., a 64 Kbps pulse code modulated (PCM) data stream, which is also known as the G.711 protocol. This digital data stream is then output to the SLICs 312 for transmission to the respective POTS telephones 120, either directly or via the in-house phone wiring network 118. In some embodiments, the digital data stream is output to the wireless telephone interface 316 and the high audio bandwidth phone interface 314 (e.g., a G.722 phone interface). As such, the SLICs 312 and the wireless telephone interface 316 include D/A converters to convert the digital data to an analog signal to be sent to the POTS telephones 120, the in-house telephone wiring network 118 and the wireless telephone 320. Alternatively, the voice packets received into the protocol stack 404 may be converted to other digital data streams of other protocols that may require decompression, for example, G.722 (where the high audio bandwidth phone interface 314 comprises a G.722 phone interface), G.726 and G.728. Such alternative digital data streams are decompressed by the signal processing module 308.

Voice signals from the POTS telephones 120 are received into the SLICs 312, converted to a digital data stream by an A/D converter within the SLICs 312 and sent to the processor unit 302. The digital data stream is then compressed (optionally), and assembled into voice packets, e.g., VoIP packets, at the protocol stack 304 for transmission over the data line 212 to the STB 102. The user interface module 306 provides the appropriate addressing such that the protocol stack 304 can properly address the voice packets.

The protocol stack 304 includes the functionality to enable IP telephony and may be a H.323 stack, which is well known in the art. Alternatively, the protocol stack 304 may be a Media Gateway Control Protocol (MGCP) stack. In this embodiment, the protocol stack 304 includes a network protocol stack, e.g., a TCP/IP or UDP/IP protocol stack or other protocol stack as dictated by the network type, as well as a link protocol stack, preferably an IEEE 1394 protocol stack, for communications over an integrated power/data line embodiment of the peripheral link 114. It is noted that the link protocol stack may be in a separate processor or chip, e.g., an i.LINK chip.

The protocol stack 304 packetizes a voice bit stream, i.e., digital voice information, to be sent across the cable network through the STB 102 and provides destination addressing for each packet. The protocol stack 304 also buffers and reassembles the voice packets and converts the packets to a digital voice bit stream, i.e., no longer packetized. The design and implementation of the protocol stack 304 for VoIP communications and other IP communications is well within the abilities of one skilled in the art; thus, no further explanation is provided.

In some embodiments, the protocol stack functionality is distributed between the STB 102 and the VoIP peripheral 106 such that the STB 102 actually performs some functionality of the protocol stack 304, while the VoIP peripheral 106 performs the remainder of the functionality of the protocol stack 304. In this embodiment, protocol stack software is downloaded into the STB 102 and run on the CPU 206. However, in preferred embodiments, the protocol stack 304 is fully implemented within the VoIP peripheral 106. Those skilled in the art will recognize that the protocol stack functionality may be distributed between the STB 102 and the VoIP peripheral 106, i.e., functional components of the protocol stack may simultaneously be in both the STB 102 and the VoIP peripheral 106.

In further embodiments, both the protocol stack 304 and the signal processing module 308 may take place entirely within the STB 102 such that uncompressed voice bit streams are communicated between the STB 102 and the VoIP peripheral 106. In this embodiment, the peripheral link 114 is preferably an integrated power/data line, such as an IEEE 1394 cable (e.g., an i.LINK cable) due to its ability to quickly transfer digital data.

The user interface module 306 is the functional portion of the processor unit 302 that provides functionality normally provided by the PSTN to the POTS equipment. For example, the user interface module 306 includes the functionality for dial tone generation, ring signal generation, off hook detection, call waiting, DTMF signaling, etc. This functionality is well understood in the art and is already implemented within cable modem delivery systems that provide telephony services to the user. Advantageously, the user interface module 306 provides the addressing means such that the protocol stack 304 can properly address the VoIP packets. For example, when a subscriber enters a telephone number, such as an area code and phone number, the user interface module 306 receives the digitized DTMF tones and determines the phone number being called or where to address the IP packets, i.e., VoIP packets so that the protocol stack 304 can properly address the IP packets for transmission over the cable network. Such addressing means may include addressing the VoIP packets to a specified server within the cable network that is able to perform a database lookup and insert the proper header information for routing on the individual VoIP packets.

The signal processing module 308 is optionally included and may be used to run complex processing of the digital data stream output from the protocol stack 304 or the digital data stream received from the respective telephone interfaces, i.e., the SLICs 312, the telephone wiring interface 313, the high audio bandwidth phone interface 314 and the wireless telephone interface 314. For example, in cases where the digital data stream is a 64 Kbps PCM data stream according to G.711, no compression or decompression is done at the signal processing module 308. However, the signal processing module 308 functions to compress or decompress the voice bit stream to meet a compression protocol that accommodates a greater number of conversations in a given bandwidth. For example, multiple 64 Kbps signals from either the protocol stack 304 may be compressed to 5.3 Kbps signals, i.e., the G.723.1 standard. Thus, the signal processing module 308 functions to provide a common compression standard between parties.

Furthermore, in order to support the high bandwidth audio phone 318, such as an ISDN phone having a 7 kHz bandwidth (in comparison to the G.711 protocol having a bandwidth of 3.3 kHz), the signal processing module 308 runs a G.722 algorithm, as known in the art. Having been processed by the G.722 algorithm within the signal processing module 308, the digital signal is sent to the high audio bandwidth phone interface 314, which is coupled to the high audio bandwidth telephone 318. As is known, the communications between the high audio bandwidth telephone 318 and the high audio bandwidth phone interface 314 are entirely digital. Furthermore, the wireless telephone interface 316 may comprise a G.722 phone interface and communicate to a digital wireless phone 320 that communicates directly with the VoIP peripheral 106. The high audio bandwidth telephone 318 and the digital wireless telephone 320 include the functionality to convert the digital signals to analog signals to interface with the user.

In another embodiment, the digital wireless phone 320 is coupled to the wireless phone interface 316; however, the signal is another protocol, other than G.722, such as the G.711 protocol. In either case, the digital wireless phone 320 is able to communicate directly with the VoIP peripheral 106. This takes advantage of VoIPs lack of coupling between a speaker and a microphone.

The SLICs 312 provide the telephone interface to the standard POTS equipment, such as POTS telephones 120 or the in-house phone wiring network 118 (to which POTS telephones may be coupled). Each SLIC 312 contains a standard interface for the POTS telephones, e.g., an RJ-11 jack. The SLICs 312 and RJ-11 jacks are well known in the art for interfacing with POTS equipment. These SLICs 312 may be configured to be separate phone lines or may all be the same phone line. Thus, the multiple SLICs can collectively support multiple independent conversations from different telephones 120. As shown, the POTS telephones may be coupled directly to the VoIP peripheral 106 via a respective SLIC 312 or the POTS telephones 120 may be coupled to the in-house phone wiring network 118, which is coupled directly to the VoIP peripheral 106.

Advantageously, in this embodiment, the processor unit 302 and the respective SLICs 312 collectively function as a converter that converts packetized voice data or digital voice packets (e.g., VoIP packets) received from the data line 212 to analog voice signals sent to the POTS telephones 120. Similarly, the processor unit 302 and the SLICs 312 also function as a converter that converts the analog voice signals received from the POTS telephones 120 to packetized voice data or digital voice packets (e.g., VoIP packets) to be transmitted to the cable network via the data line 212 and the STB 102. Thus, the VoIP peripheral 106 converts all POTS telephone calls into VoIP calls and automatically transmits them across the cable network to the intended destination. Thus, since all telephone calls made from the POTS telephones 120 are converted to VoIP (or other packet protocol) and all telephony related services are provided by the cable service provider and locally within the VoIP peripheral 106, reliance upon the PSTN for user-related features is eliminated and the cable service provider replaces the telephone service provider.

In further embodiments, the processor unit 302 includes the answering machine module 310 (also referred to as a voice messaging module 310). The answering machine module 310 functions as a typical answering machine in that if the subscriber does not answer an incoming telephone call within the prescribed number of rings, the answering machine module 310 will play an outgoing message and record a message that the subscriber may later retrieve. These messages are digitally stored, for example, within the memory 324, which is preferably a RAM backed up by a battery source. The answering machine module 310 may be integrated onto a processor (as shown) or may comprise a separate processor that is not part of the processor unit 302. By providing answering machine functionality within the VoIP peripheral 106, the subscriber is not required to purchase additional answering machine type equipment that would normally be coupled in between a POTS telephone 120 and the VoIP peripheral 106. Furthermore, the subscriber would not have to pay for remote voice messaging services.

Further details regarding the implementation and design of a digital answering machine as incorporated into a cable modem system at the subscriber location may be found in U.S. patent application Ser. No. 09/706,287, filed Nov. 3, 2000, entitled DIGITAL ANSWERING MACHINE ENABLED CABLE MODEM (hereinafter referred to as the '287 application), which is incorporated herein by reference in its entirety. The answering machine module 310 can be configured to include any of the functions of the '287 application and includes several benefits that are uniquely enabled since the answering machine functionality is located within the cable modem system. For example, similar to that described in the '287 application, depending upon addressing information (i.e., IP addressing of the VoIP call) of the incoming VoIP calls, caller ID information can be extracted from the incoming VoIP call. As such, the answering machine module 310 may provide video display messages that are sent via the data line 212 to the STB 102, then routed to the television to visually indicate to a television viewer the identity of the incoming caller. Many other unique applications described in the '287 application may also be easily applied to the answering machine module 310 of the present application.

Further advantageously, the VoIP peripheral 106 further includes the UPS 322 for providing an uninterruptible source of power for the VoIP telephony system. The UPS 322 is coupled to the power supply 116, which provides the normal full-time power to the VoIP peripheral 106. However, in the event of a power outage, backup power is supplied by a rechargeable power cell, e.g., a battery, within the UPS 322. The UPS 322 also provides backup power to the STB 102 via the power line 214 as well as provides backup power to the VoIP peripheral itself and power to operate the POTS telephone equipment. Thus, even during a power outage, the subscriber may place telephone calls via the POTS equipment. Again, these telephone calls are converted for transmission as VoIP calls. Therefore, the VoIP peripheral 106 is able to maintain telephony services completely independent from the PSTN when there is a power failure while positioned in an innocuous location, e.g., out of sight and out of the way. Uninterruptible power supplies are well known in the art, thus, no further explanation is provided.

Additionally, in some embodiments, the VoIP peripheral 106 includes hardware and software to be remotely accessed and controlled via the cable network, e.g., by a remote computer or server. Those skilled in the art will recognize that the VoIP peripheral 106 may be equipped with IP addressable software capable of hosting a Web server. The Web server in this embodiment allows users to change operational settings within the VoIP peripheral 106, such as within the answering machine module 310 (e.g., the number of rings before the answering machine module answers a call, etc.). Additionally, saved messages in the memory 324 may also be remotely retrieved via the Web server using a web browser. Similarly, other components of the VoIP peripheral 106 may be controlled via the remote Web browser, such as the signal processing module 308 and features of the user interface 306. In this embodiment, the user interface module 306 additionally functions as a web server. Thus, the user interface module 306 creates or retrieves web pages stored in memory (e.g., memory 324) that are transmitted upon request by remote servers. These web pages are used to display settings of the VoIP peripheral and receive instructions for altering the settings of the VoIP peripheral. The ability to generate, transmit and receive web pages is well known in the art. As such, in this embodiment, the user interface module 306 functions as two different types of user interfaces: an interface for the POTS telephones 120 using DTMF tones and an interface for web servers using web pages authored in a mark up language (e.g., HTML, XML, etc.).

Referring next to FIG. 4, a functional block diagram is shown of another embodiment of the STB 102 of FIG. 2 in which communications with the VoIP peripheral 106 are via a wireless link. Shown is the cable line 110, the STB 401 within a housing 210 (i.e., STB housing) containing the controller 204, the cable modem front end 202, the CPU 206, the decoder 208, uninterruptible power supply (UPS) 402 coupled to the power supply 116 of the local utility, and a wireless transceiver 404. Also shown is the VoIP peripheral 409 within the housing 326 (i.e., peripheral housing), and including a wireless transceiver 410, the processor unit 302 and the UPS 326 coupled to the power supply 116 from the local utility. Between the STB 401 and the VoIP peripheral 409 is a wireless communication link 408. Note that the set top box 401 further includes an RF receiver 132 (not shown). Many of the components of this embodiment have been previously described, thus, such description is not repeated below.

In comparison to the STB 102 of FIG. 2, the STB 401 of FIG. 4 includes wireless transceiver 404 to translate the digital voice packets received from the cable modem front end 202 into a format suitable for transmission over the wireless communication link 408 to the corresponding wireless transceiver 410 at the VoIP peripheral 409. This wireless transceiver may be any wireless standard as is known in the art, such as radio frequency (RF), infrared (IR), optical, the IEEE 802.11a standard, the IEEE 802.11b standard or the BLUETOOTH™ standard. As such, the wireless communication link 408 replaces the data line 212 of FIG. 2.

However, since the wireless communication link 408 can not be used to deliver power from the VoIP peripheral 409 to the STB 401, the STB 401 includes its own UPS 402 which is coupled to the power supply 116 of the local utility and includes a backup rechargeable battery for power during power outages. The UPS 402 delivers power to all of the components of the STB 601 that are to be used in the VoIP telephony services. Thus, the UPS 402 is coupled to the cable modem front end 202, the controller 204, the CPU 206, and the wireless transceiver 404, and optionally, to the TV decoder 208.

In this embodiment, the STB 401 is not powered by the VoIP peripheral 409. Instead the UPS 402 within the STB 401, provides continuous power, even during a power failure.

It is noted that not all of the components of the VoIP peripheral 409 are shown since such components have been previously described. The VoIP peripheral 409 includes the wireless transceiver 410 coupled to the processor unit 302 and which communicates with the STB 401 via the wireless communication link 408.

While the invention herein disclosed has been described by means of specific embodiments and applications thereof, numerous modifications and variations could be made thereto by those skilled in the art without departing from the scope of the invention set forth in the claims.

What is claimed is:

1. A packetized voice telephony system comprising:
a set top box including a cable modem front end for supporting cable television services to be provided to a television coupled to the set top box; and
a voice peripheral coupled to the set top box for supporting packetized voice telephony services provided via a cable link and through the set top box.

2. The system of claim 1 wherein the set top box is located within a first housing and the voice peripheral is located within a second housing.

3. The system of claim 1 wherein the voice peripheral converts analog voice signals into digital voice packets.

4. The system of claim 1 wherein the voice peripheral converts digital voice packets into analog voice signals.

5. The system of claim 4 wherein the digital voice packets comprise Voice over Internet Protocol (VoIP) packets.

6. The system of claim 1 wherein the voice peripheral includes a power supply for providing backup power to the set top box.

7. The system of claim 6 wherein the power supply comprises an uninterruptible power supply.

8. The system of claim 1 further comprising a power line coupled from the voice peripheral to the set top box for providing backup power to the set top box.

9. The system of claim 1 further comprising a data line coupling the voice peripheral with the set top box.

10. The system of claim 9 wherein the data line comprises a link selected from a group consisting of: an Ethernet link, a universal serial bus (USB) link, a home phone networking alliance (HPNA) link, an IEEE 1394 link and a wireless link.

11. The system of claim 9 further comprising a power line for providing backup power to the set top box.

12. The system of claim 11 wherein the data line and the power line comprise an integrated power/data line.

13. The system of claim 12 wherein the integrated power/data line conforms to the IEEE 1394 standard.

14. The system of claim 1 wherein the voice peripheral includes one or more telephone interfaces to interface with plain old telephone service (POTS) equipment.

15. The system of claim 1 wherein the voice peripheral includes one or more telephone interfaces to interface with an in-house phone wiring network.

16. The system of claim 1 wherein the voice peripheral provides backup power to subscriber plain old telephone service (POTS) equipment coupled to the voice peripheral.

17. The system of claim 1 wherein the voice peripheral further includes a wireless telephone interface for communicating with a wireless phone.

18. The system of claim 1 wherein the voice peripheral further includes a high audio bandwidth telephone interface for communicating with a high audio bandwidth telephone.

19. The system of claim 1 wherein the voice peripheral includes a processor unit, the processor unit including:
a protocol stack for supporting the packetized voice telephony services; and
a user interface module for providing telephony functionality to subscriber telephone equipment.

20. The system of claim 19 wherein the processor unit further includes an answering machine module for providing answering machine functionality for packetized voice calls.

21. The system of claim 1 wherein the set top box is located proximate to a television.

22. The system of claim 1 further comprising a remote control for operating the set top box.

23. The system of claim 1 wherein the set top box further comprises a receiver for receiving control signals from a remote control used to operate the set top box.

24. A packetized voice telephony system comprising:
a set top box including a cable modem front end;
a voice peripheral coupled to the set top box and supporting packetized telephony services provided via the set top box, wherein the voice peripheral converts packetized voice data received from the set top box to analog voice signals to be routed to subscriber POTS equipment coupled to the voice peripheral and converts analog voice signals from the subscriber POTS equipment coupled to the voice peripheral to packetized voice data to be routed to a cable network through the set top box.

25. The system of claim 24 wherein the voice peripheral converts Voice over Internet Protocol (VoIP) packets received from the set top box to the analog voice signals to be routed to the subscriber POTS equipment coupled to the voice peripheral and converts the analog voice signals from the subscriber POTS equipment coupled to the voice peripheral to VoIP packets to be routed to the cable network through the set top box.

26. The system of claim 24 wherein the voice peripheral further includes a power supply for providing backup power to the set top box.

27. A packetized voice telephony system comprising:
a set top box located within a first housing and including:
a cable modem front end for receiving cable television services and packetized voice calls, wherein the cable modem front end performs television tuning and demodulation, wherein the cable modem front end separates the cable television services and the packetized voice calls; and
a television decoder coupled to the cable modem front end; and
a voice peripheral located within a second housing external to the first housing and coupled to the set top box for receiving the packetized voice calls from the set top box and for supporting packetized voice telephony services and including one or more telephone interfaces for coupling to subscriber POTS equipment.

28. The system of claim 27 wherein the voice peripheral includes a protocol stack for converting the packetized voice calls received from the set top box to digital data streams.

29. The system of claim 28 wherein the protocol stack comprises a stack selected from the group consisting of: an H.323 protocol stack and a Media Gateway Control Protocol (MGCP) stack.

30. The system of claim 28 wherein the voice peripheral further includes a telephone interface for converting the digital data stream to an analog voice signal.

31. The system of claim 28 wherein the voice peripheral further includes a user interface module coupled to the protocol stack for providing telephony related services to POTS equipment to be coupled to the voice peripheral.

32. The system of claim 28 wherein the voice peripheral further includes a signal processing module coupled to the protocol stack.

33. The system of claim 28 wherein the voice peripheral further includes an answering machine module for providing answering machine functionality for the packetized voice calls.

34. The system of claim 27 wherein the voice peripheral further includes one or more telephone interfaces to allow coupling to POTS equipment.

35. The system of claim 27 wherein the voice peripheral and the set top box collectively share a protocol stack for converting the packetized voice calls to digital data streams.

36. The system of claim 27 wherein the voice peripheral includes a power supply for providing backup power to the set top box in the event of a power outage.

37. A voice peripheral of a packetized voice cable telephony system comprising:
a housing external to and couplable to a set top box housing, the housing including:
a processor unit adapted to be coupled to a set top box including a cable modem front end, wherein the processor unit supports packetized voice telephony services; and
one or more telephone interfaces coupled to the processor unit adapted to couple to subscriber POTS equipment.

38. The voice peripheral of claim 37 wherein the processor unit comprises:
a protocol stack for converting packetized voice calls to digital voice data stream; and
a user interface module for providing user-related features to telephones coupled to the one or more telephone interfaces.

39. The voice peripheral of claim 37 wherein the processor unit further comprises a signal processing module

40. The voice peripheral of claim 37 wherein the processor unit further includes an answering machine module for providing answering machine functionality for packetized voice calls.

41. The voice peripheral of claim 37 wherein the processor unit supports packetized voice calls using Voice over Internet Protocol.

42. The voice peripheral of claim 41 wherein the processor unit further comprises a Voice over Internet Protocol stack.

43. The voice peripheral of claim 37 wherein respective ones of the one or more telephone interfaces convert digital data streams to analog voice calls.

44. A method for providing a packetized voice telephony system comprising:
providing a set top box including a cable modem front end for supporting cable television services to be provided to a television coupled to the set top box; and
providing a voice peripheral coupled to the set top box for supporting packetized voice telephony services provided via a cable link and through the set top box.

45. A method for providing packetized voice telephony comprising:
receiving digital voice packets from a set top box including a cable modem front end that supports cable television services, wherein the digital voice packets represent a telephone call;
converting the digital voice packets to an analog voice signal; and
transmitting the analog voice signal to subscriber plain old telephone service (POTS) equipment.

46. The method of claim 45 further comprising providing user-related telephony features to the subscriber POTS equipment.

47. The method of claim 45 wherein the receiving comprises receiving Voice over Internet Protocol (VoIP) packets from the set top box.

48. The method of claim 45 further comprising providing backup power to the set top box in the event of a power outage.

49. The method of claim 45 further comprising providing backup power to the subscriber POTS equipment in the event of the power outage.

50. A method of Voice over Internet Protocol (VoIP) telephony comprising:
receiving an analog voice signal from subscriber plain old telephone service (POTS) equipment representing a telephone call to a location specified by a telephone number;
converting the analog voice signal of the telephone call to digital voice packets; and
transmitting the digital voice packets to a set top box including a cable modem front end, wherein the digital voice packets will be transmitted to the location by a cable network.

51. The method of claim 50 further comprising providing user-related telephony features to the subscriber POTS equipment.

52. The method of claim 50 wherein the converting comprises converting the analog voice signal to Voice over Internet Protocol (VoIP) packets.

53. The method of claim 50 further comprising providing backup power to the set top box in the event of a power outage.

54. The method of claim 50 further comprising providing backup power to the subscriber POTS equipment in the event of the power outage.
